(19) United States
(12) Patent Application Publication
(10) Pub. No.: US 2010/0238552 A1
(43) Pub. Date: Sep. 23, 2010

(54) RETROREFLECTIVE ARTICLE

(75) Inventor: Sheng-Hsu TSAI, Chiayi County (TW)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Avants International Corp.

(21) Appl. No.: 12/725,748

(22) Filed: Mar. 17, 2010

(30) Foreign Application Priority Data
Mar. 20, 2009 (TW) 098204399

(51) Int. Cl. G02B 5/128; G02B 5/136

(52) U.S. Cl. 359/540; 359/546

(57) ABSTRACT

A retroreflective article includes: a retroreflective layer including a binding matrix and a plurality of optical elements, the binding matrix having an upper surface, the optical elements being bonded to and protruding from the upper surface of the binding matrix and being capable of directing light, that enters the optical elements, in a direction such that the light can be substantially returned toward a light source from which the light is emitted; a transparent printable layer formed on the retroreflective layer and cooperating with the binding matrix to enclose the optical elements; and a colored layer printed on the printable layer.

### CROSS-REFERENCE TO RELATED APPLICATION

This application claims priority of Taiwanese Patent Application No. 098204399, filed on Mar. 20, 2009.

### BACKGROUND OF THE INVENTION

1. Field of the invention

This invention relates to a retroreflective article, more particularly to a retroreflective article including a retroreflective layer and a printable layer formed on the retroreflective layer and printed with a colored layer.

2. Description of the related art

Referring to FIG. 1, U.S. Pat. No. 5,378,520 discloses a conventional retroreflective article that includes abase layer 13 of a binder material, microspheres 14 embedded partially in the base layer 13, and a cover film (not shown) covering the microspheres 14 and bonded to the base layer 13. Each microsphere 14 has a bottom surface that is vapor-deposited with a specularly reflective material 15, such as aluminum or silver, so as to forma retroreflective element supported on the base layer 13.

U.S. Pat. No. 6,306,459 discloses another conventional retroreflective article that includes a colored layer and microspheres embedded partially in the colored layer. The colored layer contains a polymer, reflective flakes embedded in the polymer, and a dye bonded covalently to the polymer so as to permit the retroreflective article to exhibit color under retroreflective conditions. However, the conventional retroreflective article can exhibit solely one color, and is unable to exhibit multiple colors and a multi-color image or pattern. It has been proposed in the art to color the microspheres so as to provide a multi-color effect. However, it is complicated and expensive to color the microspheres.

### SUMMARY OF THE INVENTION

Therefore, an object of the present invention is to provide a retroreflective article that can overcome the aforesaid drawbacks associated with the prior art.

According to the present invention, there is provided a retroreflective article that comprises: a retroreflective layer including a binding matrix of a polymeric material and a plurality of optical elements, the binding matrix having an upper surface, the optical elements being bonded to and protruding from the upper surface of the binding matrix and being capable of directing light, that enters the optical elements, in a direction such that the light can be substantially returned toward a light source from which the light is emitted; a transparent printable layer formed on the retroreflective layer and cooperating with the binding matrix to enclose the optical elements, the printable layer having a flat surface opposite to the retroreflective layer; and a colored layer printed on the flat surface of the printable layer.

### BRIEF DESCRIPTION OF THE DRAWINGS

In drawings which illustrate an embodiment of the invention,

FIG. 1 is a fragmentary sectional view of a conventional retroreflective article;

FIG. 2 is a perspective view of the preferred embodiment of a retroreflective article according to the present invention;

FIG. 3 is a sectional view of the preferred embodiment; and

FIGS. 4 and 5 are sectional views illustrating consecutive steps of removing a liner layer from the preferred embodiment.

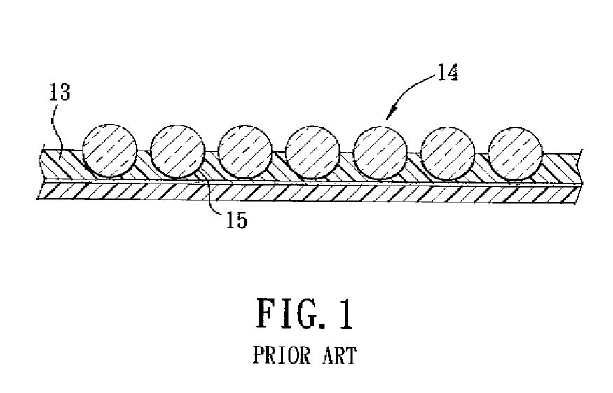

### DETAILED DESCRIPTION OF THE PREFERRED EMBODIMENT

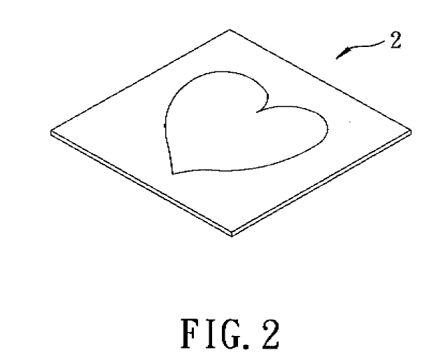

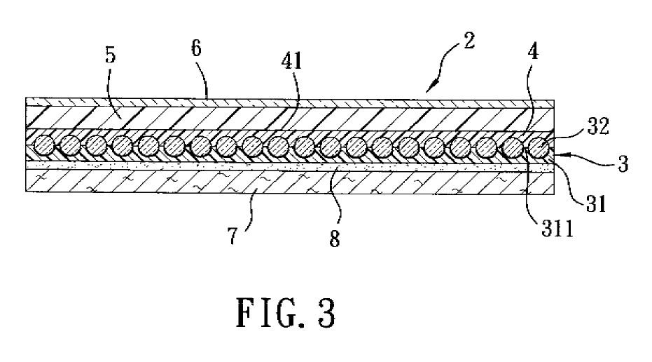

FIGS. 2 and 3 illustrate the preferred embodiment of a retroreflective article according to the present invention.

The retroreflective article 2 includes: a retroreflective layer 3 including a binding matrix 31 of a polymeric material and a plurality of optical elements 32, the binding matrix 31 having an upper surface 311, the optical elements 32 being bonded to and protruding from the upper surface 311 of the binding matrix 31 and being capable of directing light, that enters the optical elements 32, in a direction such that the light can be substantially returned toward a light source (not shown) from which the light is emitted; a transparent printable layer 4 formed on the retroreflective layer 3 and cooperating with the binding matrix 31 to enclose the optical elements 32, the printable layer 4 having a flat surface 41; and a colored layer 5 printed on the flat surface 41 of the printable layer 4.

Preferably, the printable layer 4 is made from a hot melt adhesive. The hot melt adhesive is made from a material selected from the group consisting of ethylene-vinyl-acetate copolymer, ethylene-acrylate copolymer, polyolefins, polyamides, polyesters, and polyurethanes.

Preferably, the colored layer 5 comprises a colored ink, and can be printed on the flat surface 41 of the printable layer 4 through transfer printing techniques, screen printing techniques, or roller printing techniques. Alternatively, the colored layer 5 can be made from a polyethyl terephthalate layer with a colored ink printed thereon.

Examples of the polymeric material are polyurethanes, polyureas, epoxy resins, polyacrylates, and polyamides.

The optical elements 32 are in the form of microspheres of glass vapor-deposited with a reflective coating (not shown), such as aluminum, silver, and a dielectric layer.

The retroreflective article 2 can further include a transparent protective layer 6 covering the colored layer 5, and a releasable liner layer 7 bonded releasably to one side of the binding matrix 31 opposite to the retroreflective layer 3 through an adhesive 8. The protective layer 6 can be made from the hot melt adhesive or polyvinyl chloride.

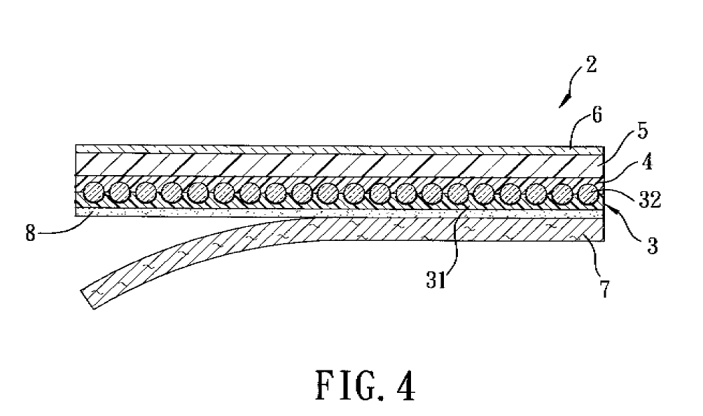

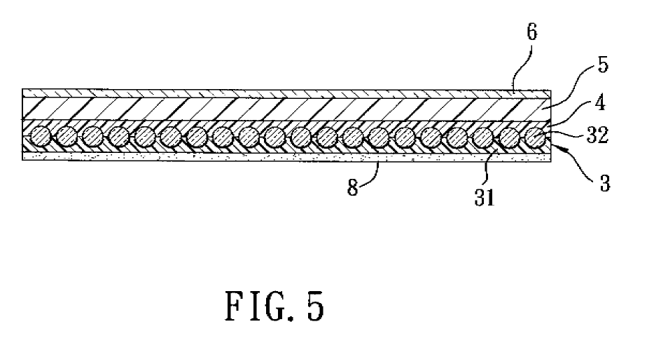

Referring to FIGS. 4 and 5, when the retroreflective article 2 is to be attached to an object (not shown), the liner layer 7 is removed therefrom so as to permit bonding of the retroreflective article 2 to the object through the adhesive 8.

Table 1 shows the results of a retroreflectivity test of a specimen of the retroreflective article 2 of this invention. The test was conducted according to ECE regulation. The results show that the measured retroreflectivities for all the test conditions shown in Table 1 are greater than the minimum requirements.

TABLE 1

| | Minimum | Measured |
|---|---|---|
| | requirement, | value, |
| Function | mcd/lx | mcd/lx |
| 90′ H-V | 5 | 76.9 |
| 90′ H-5U | 5 | 29.0 |
| 90′ H-5D | 5 | 27.9 |
| 90′ 10U-V | 2.8 | 24.8 |
| 90′ 10D-V | 2.8 | 25.6 |
| 90′ 20R-5U | 2.5 | 19.6 |
| 90′ 20L-5U | 2.5 | 21.3 |
| 90′ 20L-5D | 2.5 | 21.7 |
| 90′ 20R-5D | 2.5 | 20.0 |

With the inclusion of the printable layer 4 and the colored layer 5 in the retroreflective article 2 of this invention, the retroreflective article 2 can exhibit a multi-color image or pattern and the aforesaid drawbacks associated with the prior art can be eliminated.

With the invention thus explained, it is apparent that various modifications and variations can be made without departing from the spirit of the present invention.

What is claimed is:

1. A retroreflective article, comprising:
a retroreflective layer including a binding matrix of a polymeric material and a plurality of optical elements, said binding matrix having an upper surface, said optical elements being bonded to and protruding from said upper surface of said binding matrix and being capable of directing light, that enters said optical elements, in a direction such that the light can be substantially returned toward a light source from which the light is emitted;
a transparent printable layer formed on said retroreflective layer and cooperating with said binding matrix to enclose said optical elements, said printable layer having a flat surface opposite to said retroreflective layer; and
a colored layer printed on said flat surface of said printable layer.

2. The retroreflective article of claim 1, wherein said printable layer is made from a hot melt adhesive.

3. The retroreflective article of claim 2, wherein said hot melt adhesive is made from a material selected from the group consisting of ethylene-vinyl-acetate copolymer, ethylene-acrylate copolymer, polyolefins, polyamides, polyesters, and polyurethanes.

4. The retroreflective article of claim 1, wherein said colored layer comprises a colored ink.

5. The retroreflective article of claim 1, wherein said optical elements are in the form of microspheres of glass

6. The retroreflective article of claim 1, further comprising a transparent protective layer covering said colored layer.

7. The retroreflective article of claim 1, further comprising a releasable liner layer bonded releasably to one side of said binding matrix opposite to said retroreflective layer.
